(19) United States
(12) Patent Application Publication
(10) Pub. No.: US 2007/0230101 A1
(43) Pub. Date: Oct. 4, 2007

(54) Modular portable computer system

(76) Inventors: Hong W. Wong, Portland, OR (US); Wah Yiu Kwong, Beaverton, OR (US); Ed H. Kohlman, Tigard, OR (US); Kai L. Yeung, Portland, OR (US); Daryl J. Nelson, Beaverton, OR (US); Murali Veeramoney, Beaverton, OR (US); Hue V. Lam, Portland, OR (US); George H. Daskalakis, Forest Grove, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/398,128

(22) Filed: Apr. 4, 2006

(51) Int. Cl. G06F 1/16

(52) U.S. Cl. 361/683

(57) ABSTRACT

According to one embodiment, a system is disclosed. The system includes a chassis including a plurality of hardware components and a system board having a central processing unit (CPU). The system board is adaptable to be mounted with common interface features within the chassis with the CPU facing the bottom of the chassis or with the CPU facing away from the bottom of the chassis. Other embodiments may be described.

### FIELD OF THE INVENTION

The present invention relates to computer systems; more particularly, the present invention relates to computer system design.

### BACKGROUND

Mobile computer systems, such as portable computer system computers, may be typically manufactured based on a standard factory design, with limited interchangeability of parts within the line of the manufacture or between manufacturers. However, there has been a recent demand by portable computer system computer users to have a capability of purchasing systems that may be physically custom designed. Currently, such capabilities may not be available since custom designing a portable computer system computer system would likely require the entire system be redesigned each time a new configuration is requested. Such redesign is not feasible.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a conventional computer system manufacturing process;

FIGS. 3A & 3B illustrate one embodiment of a computer system manufacturing process;

FIG. 4 illustrates one embodiment of a system board placement;

FIG. 5 illustrates another embodiment of a system board placement;

FIG. 6 illustrates one embodiment of a system board;

FIG. 7 illustrates one embodiment of a system board with an input/output expansion board;

FIG. 8 illustrates one embodiment of a system board in a portable computer system computer system chassis;

FIG. 9 illustrates another embodiment of a system board in a portable computer system computer system chassis;

FIG. 10 illustrates yet another embodiment of a system board in a portable computer system computer system chassis;

FIG. 11 illustrates one embodiment of a portable computer system computer frame;

FIG. 12 illustrates one embodiment of a portable computer system computer;

FIG. 13 illustrates one embodiment of a portable computer system computer;

FIG. 14 illustrates one embodiment of a portable computer system computer lid attachment; and

FIG. 15 illustrates one embodiment of a portable computer system computer.

### DETAILED DESCRIPTION

A modular portable computer system computer system is described. In the following detailed description of the present invention, numerous specific details may be set forth in order to provide a thorough understanding of the present invention. However, it will be apparent to one skilled in the art that the present invention may be practiced without these specific details. In other instances, well-known structures and devices may be shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification may be not necessarily all referring to the same embodiment.

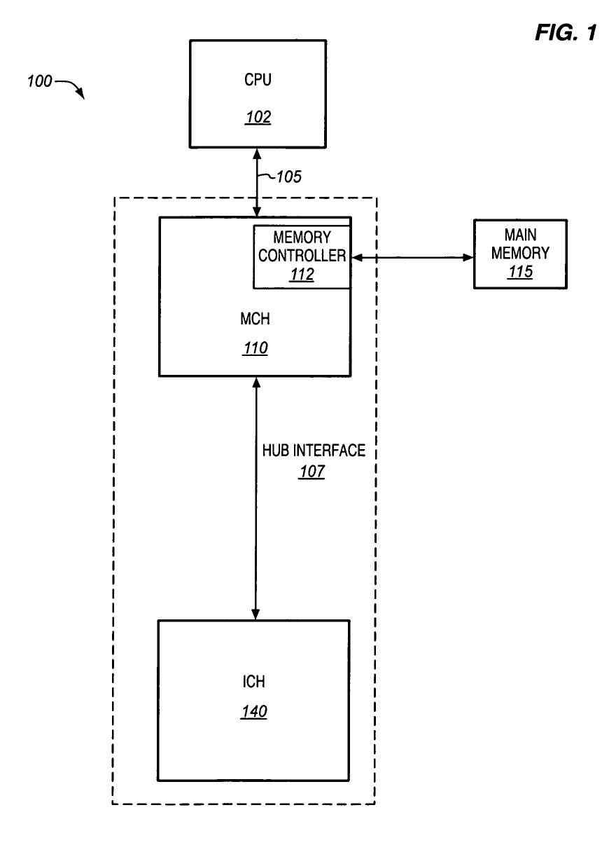

FIG. 1 is a block diagram of one embodiment of a computer system 100. According to one embodiment, computer system 100 is a mobile computer system (e.g., a laptop, or portable computer system computer). Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 may also be coupled to bus 105. Chipset 107 includes a memory control hub (MCH) 110. MCH 110 may include a memory controller 112 that is coupled to a main system memory 115. Main system memory 115 stores data and sequences of instructions that may be executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories. MCH 110 may be coupled to an input/output control hub (ICH) 140 via a hub interface. ICH 140 provides an interface to input/output (I/O) devices within computer system 100.

The above described components (e.g., CPU 102 and chipset 107 may be typically mounted on a system board. Failure rates of system board components within portable computer system computer systems may be rather high, with the current system board failure rate being approximately 1%. However, when a system board failure occurs, it is often difficult to access the system board for repair or replacement.

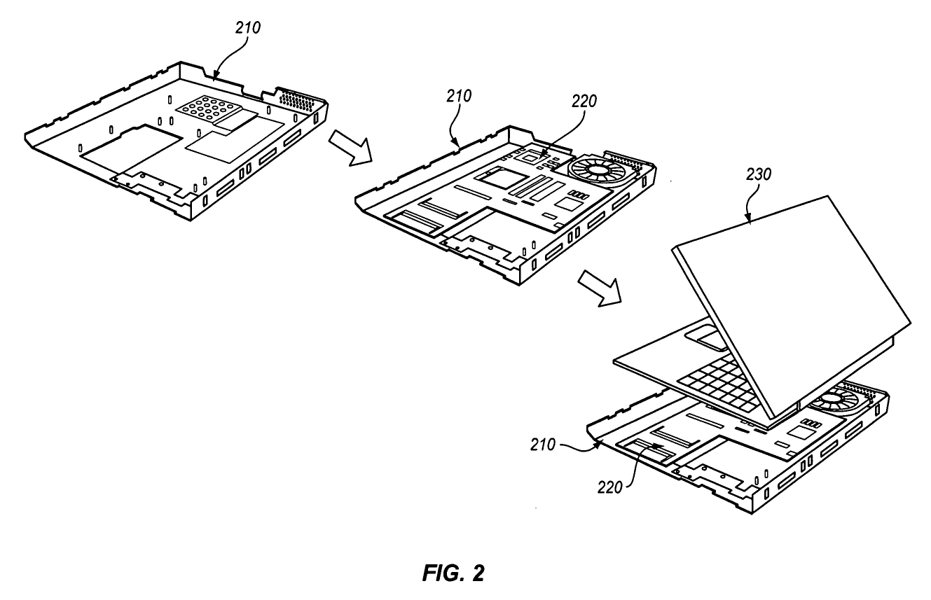

FIG. 2 illustrates a conventional portable computer system assembly design, which exemplifies the problem with system board access. The assembly of the portable computer system begins with a tray 210. Subsequently, a system board 220 is added along with a thermal solution and other components. Finally, a cover is added to complete the portable computer system.

The cover 230 includes a keyboard, LCD monitor and other input/output (I/O) components that may be coupled to system board 220 via cables and connectors. Therefore, in order to access the system board upon a failure occurring, many components typically need to be disassembled. In some instances the disassembly process may take up more than one hour, depending on the skill of the technician.

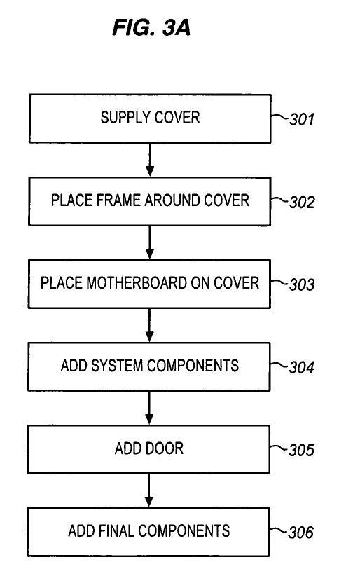

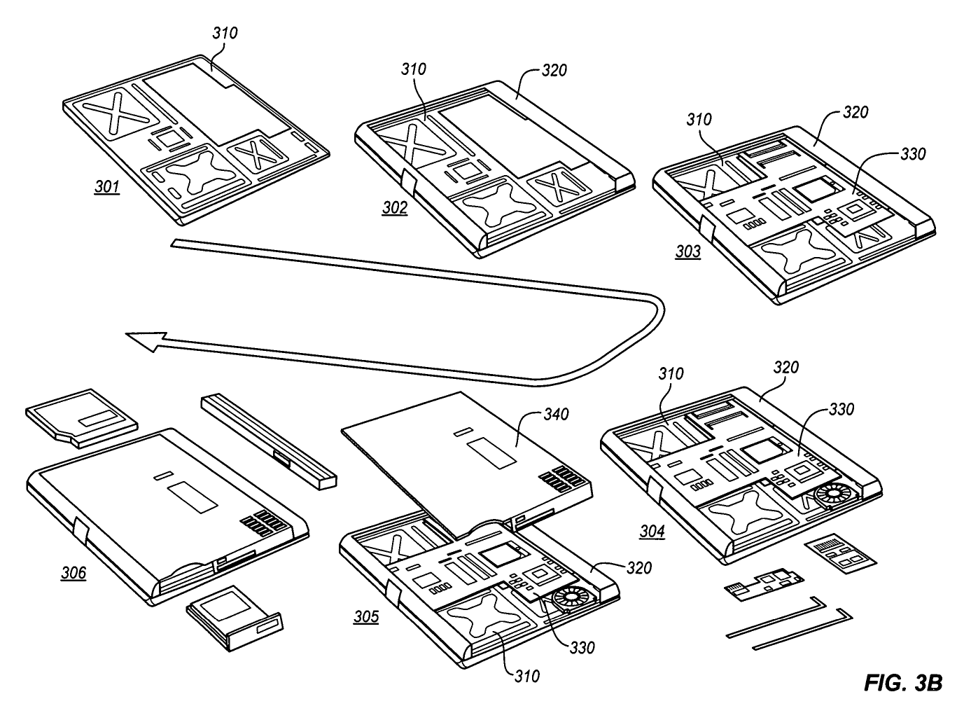

FIGS. 3A and 3B illustrate one embodiment of a portable computer system assembly design which simplifies system board access. FIG. 3A is a flow diagram illustrating the assembly, while FIG. 3B illustrates embodiments of the design performed at each operation. At operation 301, a cover 310 is supplied. The cover 310 may be the underside of the system keyboard.

At operation 302, a frame 320 is placed around cover 310. At operation 303, a system board 330 is placed on top of the cover. In one embodiment, system board 330 is inserted so that the primary side faces down (e.g., mounted major components, such as CPU, heat pipe, etc., towards the keyboard). However in other embodiments, system board 330 is inserted so that it faces up (e.g., mounted major components, such as CPU, heat pipe, etc., away from the keyboard).

At operation 304, other components may be added (e.g., thermal management components, I/O expansion card, adapters, etc). In one embodiment, stiffeners may be added to maintain the structural strength of the chassis. At operation 305, door 340 is added. In another embodiment, the stiffeners may be integrated into door 340 to simplify the assembly (e.g., by minimizing the assemble pieces).

In other embodiments, structural frames may also be designed on cover 320 and door 340 (e.g., housing for the electronics and peripherals) to maintain the structural soundness of portable computer system. The structural frames may be in the form of alloy metal frames. Another alternative is to attach system board 330 to an inner frame member that fits and attaches to outer frame 320. Other components could in this case mount to this inner frame member.

At operation 306, the final components may be added to the portable computer system. Such components may include an optical drive, hard disk drive, battery, lid, etc. Though FIG. 3 shows that system board 330 is placed into the system, an alternative design approach is to provide a centralized docking connector on system board 330 and allow system board 330 to dock to a back plane (or breakout board) for feeding signals to other parts of the system (e.g., Low Voltage Differential Signaling (LVDS) signals to the liquid crystal display (LCD) panel on the lid, speakers, etc.). This alternative design may be similar to an NLX system board form factor design in desktop computer systems

As discussed above, the system board may be placed in the chassis with core logic components facing up or down. Note that operations 301-306 are not all required and do not have to be practiced in the same order as illustrated here, as one of ordinary skill in the relevant art would appreciate based at least on the teachings provided herein.

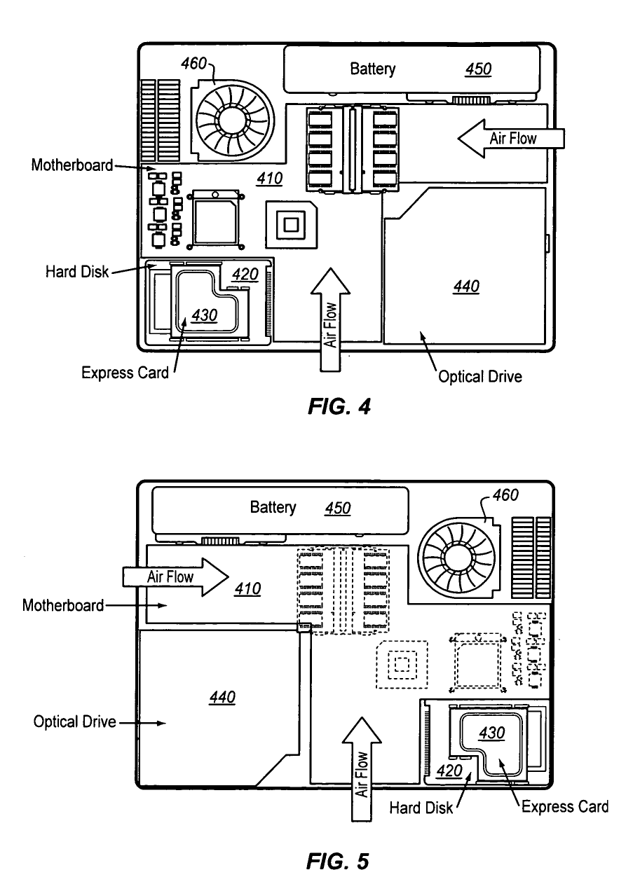

FIG. 4 illustrates one embodiment of the system board 410 placed in a system chassis with the CPU side facing up. In this embodiment, an optical drive 440 is accessed on the right side of the system, while an express card 430 is accessed on the left side. Further, the chassis includes a hard disk drive 420 and a cooling fan 460 to provide air flow through the chassis.

FIG. 5 illustrates another embodiment where the same system board 410 is placed in the system chassis with the CPU side facing down. In this embodiment, the optical drive 440 is accessed on the left side of the system, while the express card 430 is accessed on the right side. The dual system board mounting scheme enables the design of two portable computer system platforms; one that allows the system board 410 to be mounted with CPU side of the system board facing up, and another which allows the system board 410 to be mounted with CPU side facing down. Thus, one system board may be designed for multiple portable computer system chassis designs.

Further, the dual system board mounting may enable additional design options. First, all system connectors may be designed with a set targeted for the CPU side facing up, and another set with the CPU side facing down. In another embodiment, one set of connectors may be designed to work with both the CPU side up or CPU down system board mounting schemes.

Adapters or cabling may be included to handle the embodiment where the system board is flipped, such as reversing the signal pin out on the keyboard Flexible Printed Circuit (FPC) (e.g., flex cable), or the use of the rounded cable which allows the cable connector housing be rotated to aligned with the mating connector on the system board. The system board may be shipped with additional cables or adapters to support different mounting schemes.

According to one embodiment, a common system board may also be implemented for multiple portable computer system form factors. For instance a single system board would be designed for various portable computer system display sizes, such as: 14.1″ 4×3, 14.1″ 16×10, 15.1″ 4×3, 15.4″ 16×10 LCD display aspect ratios. The system board designed for the smaller form factor, such as 14.1″ 16:10 form factor or 14.1″ 4:3 form factor boards may be mounted in the 15″ 4:3 or 15.4″ 16:10 form factor platforms. The system board for the smaller form factor (the 14.1″ 16:10 or 14.1″ 4:3 form factors) is referred to as “Mini mobile Form Factor board—MMFF”, while the bigger one is referred to as “Standard mobile Form Factor board—SMFF”.

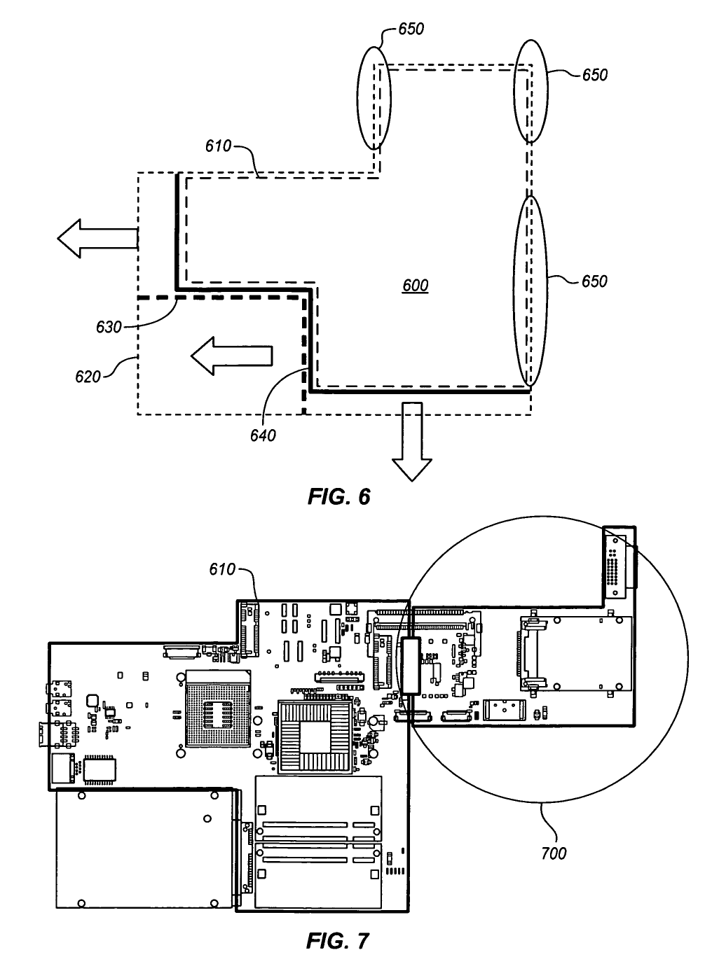

FIG. 6 illustrates one embodiment of a system board 600. Outline 610 is the basic system board 600 design, which enables system board 600 to fit in a MMFF. Outline 620 illustrates the space allotted for a SMFF system board, while outline 630 illustrates the space allotted for a variation SMFF system board. Thus, outline 640 shows the direction in which system board 600 may be expanded in larger SMFF systems.

In order to implement the common system board, the CPU 102, and chipset 107 location may be fixed to allow for the design of a common thermal solution for the chassis. Further, system board 600 may be extended to allow peripherals or adapter cards to be mounted directly to system board 600 if needed. Further, the additional board space allows additional space for electronics for product differentiations. Outline 650 indicates the areas to which a peripheral/adapter card may be mounted to system board 600. FIG. 7 illustrates one embodiment of an I/O expansion card coupled to system board 600.

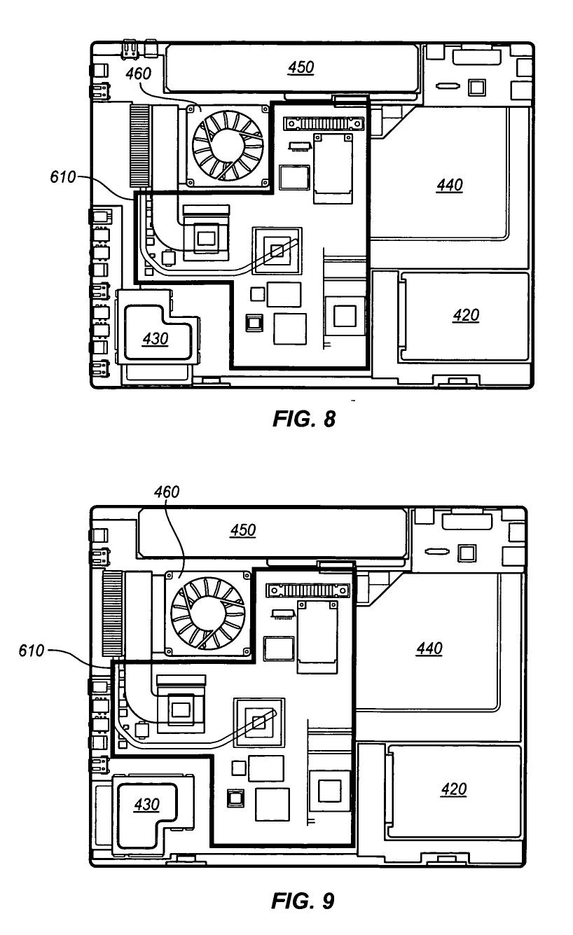

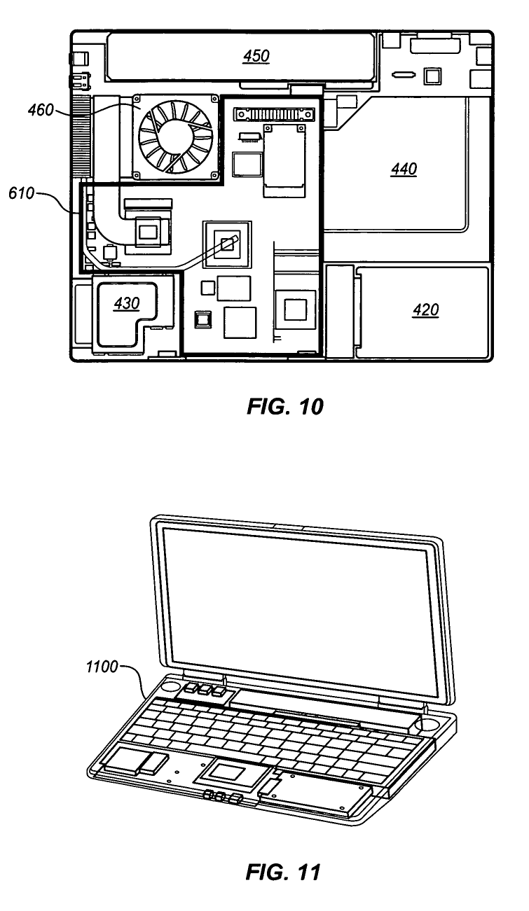

FIGS. 8-10 illustrate embodiment of the same system board 600 mounted in different portable computer system chassis. FIG. 8 illustrates one embodiment of the MMFF system board 600 mounted in a 15.4″ 16:10 chassis. FIG. 9 illustrates one embodiment of the MMFF system board 600 mounted in a 15″ 4:3 chassis, while FIG. 10 illustrates one embodiment of the MMFF system board 600 mounted in a 14.1″ 4:3 chassis. The figures show the same CPU 102 core mounted on system board 600. Further, the outline and mounting holes may be fixed for all essential components. Moreover, the air flow paths may be defined and vent locations and sizes may be specified to meet different system thermal requirements.

According to one embodiment, portable computer systems may be physically customized to conform to individual user preferences. In such an embodiment, a modular portable computer system design is implemented to minimize platform cost, while other components of the platform may be chosen by a user. A first operation in providing a customized portable computer system is to determine a common form factor, with common system board mounting features, keep out may be as and other common interfaces. For example, a 15″ 4:3 form factor with a MMFF system board 600 as shown in FIG. 8 may be implemented.

Also, the common form factor would be designed to permit a single system board design for multiple chassis designs, as discussed above with respect to FIGS. 4 and 5. The next operation in providing a customized portable computer system is to design a chassis supported only by the structural frame. For example, the platform at the stage is supported by a structural frame and includes only a standardized skin attachment. At this stage, the system has sufficient shielding to pass Electromagnetic Interference (EMI) certification. FIG. 11 illustrates one embodiment of a portable computer system computer frame 1100 at this stage.

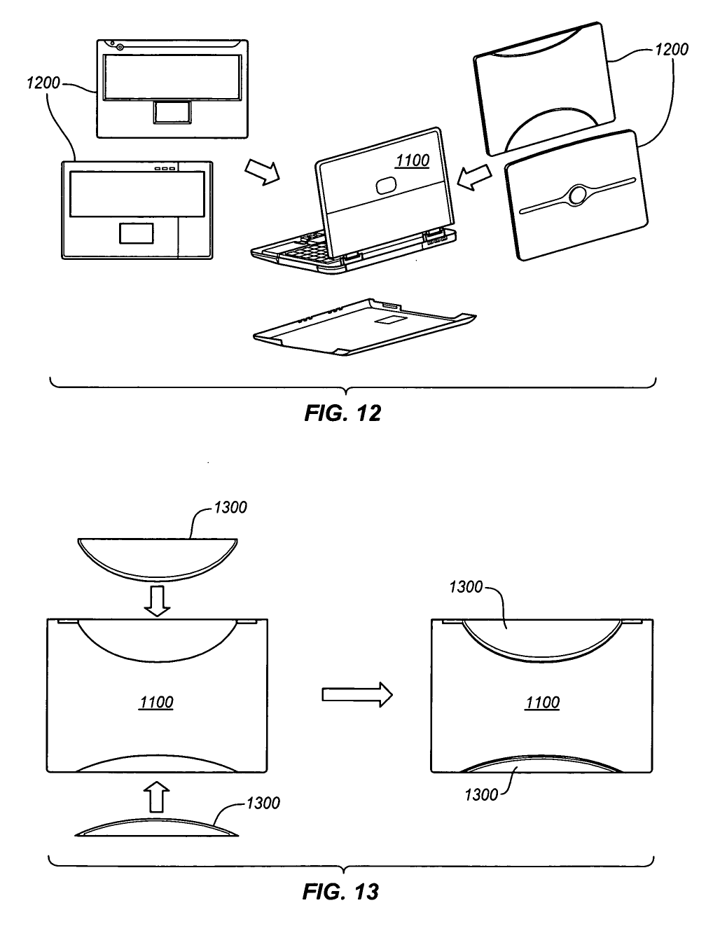

Subsequently, skins of various designs may be attached using standardized attachment points on the base of the portable computer system. Thus, different skins may be attached to the same platform, or a different platform having the same form factor. FIG. 12 illustrates one embodiment of skins 1200 that may be attached to a portable computer system. FIG. 13 illustrates another embodiment of a portable computer system computer where a snap on piece 1300 may be added to create different look and feel.

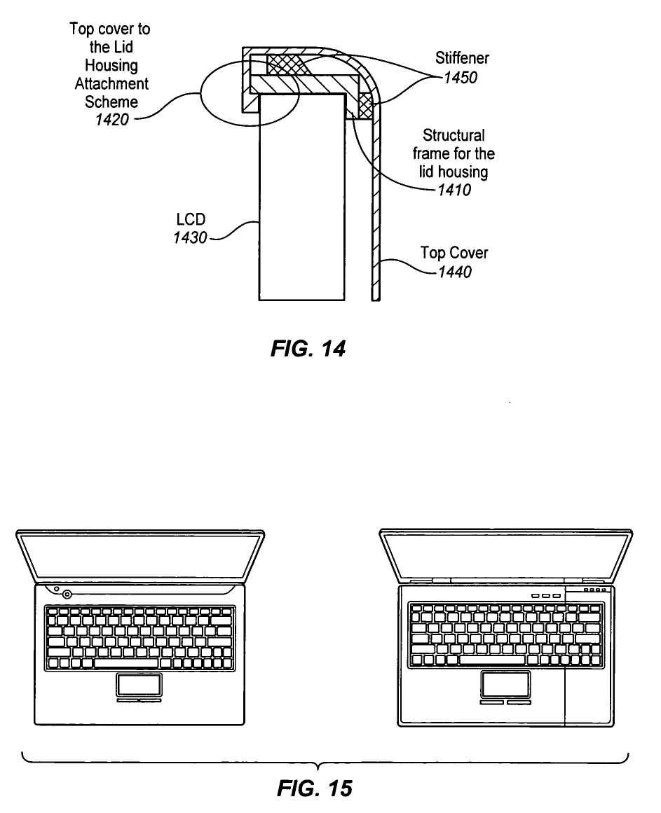

FIG. 14 illustrates a cross-section view of one embodiment of a lid attachment mechanism for attaching a top cover skin 1300 to a structural frame 1410 of a lid housing 1420. FIG. 15 illustrates one embodiment of completed portable computer systems with the same base design, but with different industrial designs by changing the skin and other interchangeable components, such as the touch pad, and mouse buttons.

The above-described modular portable computer system computer system enables a “design and sell” concept for portable computer system computer systems in which end users may customize the design of systems for purchase.

Whereas many alterations and modifications of the present invention will no doubt become apparent to a person of ordinary skill in the art after having read the foregoing description, it is to be understood that any particular embodiment shown and described by way of illustration is in no way intended to be all inclusive in nature. Therefore, references to details of various embodiments are not intended to limit the scope of the claims which in themselves recite only those features regarded as essential to the invention.

What is claimed is:

1. A method of manufacturing a portable computer system, comprising:
placing a common mounting frame with features around a cover piece;
placing a system board on the cover piece;
adding a stiffener piece to maintain structural strength of the system; and
placing a door piece on the frame.

2. The method of claim 1 further comprising adding a first set of components prior to adding the stiffener piece.

3. The method of claim 2 wherein the first set of components comprise one or more of thermal management components, an I/O expansion card, and one or more I/O adapters.

4. The method of claim 2 further comprising adding a second set of components after placing the door piece on the frame.

5. The method of claim 4 wherein the second set of components comprise one or more of an optical drive, hard disk drive and battery.

6. The method of claim 4 further comprising adding structural frames into the cover piece and door piece to maintain structural soundness of the system.

7. The method of claim 1 wherein placing the system board on the cover piece comprises mounting the system board so that the system board is accessible by removing only the cover piece.

8. The method of claim 7 wherein the system board is mounted on the cover piece with system board components facing away from the cover piece.

9. The method of claim 7 wherein the system board is mounted on the cover piece with system board components facing toward the cover piece.

10. A portable computer system comprising:
a chassis including:
a plurality of hardware components; and
a system board, having a central processing unit (CPU), adaptable to be mounted in multiple orientations within the chassis wherein the CPU faces the bottom of the chassis or the CPU faces away from the bottom of the chassis; and
a display device.

11. The system of claim 10 wherein the system board is configured to be placed in the chassis whether the chassis has a first form factor or a second form factor.

12. The system of claim 11 wherein the first form factor is a 14.1″ 16:10 and the second form factor is a 14.1″ 4:3 form factor.

13. The system of claim 10 further comprising an adaptor card coupled to the system board.

14. The system of claim 10 further comprising connectors adaptable to be coupled to the system board whether the CPU is facing the bottom of the chassis or facing away from the bottom of the chassis.

15. The system of claim 10 further comprising a structural frame to support the chassis.

16. The system of claim 15 further comprising removable skins attached to the structural frame.

17. The system of claim 16 further comprising an attachment mechanism to attach the removable skin to the structural frame.

18. A method of manufacturing a modular portable computer system, comprising:
establishing a form factor for a system chassis;
supporting the chassis with a structural frame;
mounting a standard skin attachment to the structural frame; and
mounting a removable skin attachment to the structural frame.

19. The method of claim 18 wherein the computer system has sufficient shielding to pass Electromagnetic Interference (EMI) certification before the standard skin attachment has been mounted to the structural frame.

20. The method of claim 19 wherein the standard skin attachment includes EMI shielding provisions for EMI containment.

21. The method of claim 18 further comprising mounting a snap on piece on the structural frame.

22. The method of claim 21 wherein the removable skin attachment and the snap on piece mounted to the structural frame via an attachment mechanism.

23. A portable computer system chassis comprising:
a plurality of hardware components; and
a system board, having a central processing unit (CPU), adaptable to be mounted in multiple orientations within the chassis wherein the CPU faces the bottom of the chassis or the CPU faces away from the bottom of the chassis.

24. The chassis of claim 23 further comprising an adaptor card coupled to the system board.

25. The system of claim 23 further comprising connectors adaptable to be coupled to the system board whether the CPU is facing the bottom of the chassis or facing away from the bottom of the chassis.
